(19) United States
(12) Patent Application Publication
(10) Pub. No.: US 2026/0370755 A1
(43) Pub. Date: Nov. 19, 2026

(54) CRYPTOGRAPHICALLY-AUTHENTICATED OPERATIONAL CONSTRAINTS FOR TELEPHONE CALLS

(71) Applicant: Numeracle, Inc., Arlington, VA (US)

(72) Inventors: Pierce Andrew Gorman, Lee's Summit, MO (US); Brett Spencer Nemeroff, Austin, TX (US); Samuel Rislove Etler, San Francisco, CA (US)

(21) Appl. No.: 19/430,795

(22) Filed: Dec. 23, 2025

Related U.S. Application Data
(60) Provisional application No. 63/806,811, filed on May 16, 2025.

(51) Int. Cl. H04M 3/42; H04L 9/32; H04L 65/1104

(52) U.S. Cl. CPC H04M 3/42042; H04L 9/3213; H04L 9/3247; H04L 65/1104

(57) ABSTRACT

Telephone calls can be intelligently delivered based on an evaluation of operational constraints as described herein. In one example, a method performed by one or more processors associated with a telecommunications service provider includes receiving a communication associated with a caller requesting to make a telephone call to a recipient. The communication includes operational constraints encoded into the communication. The method can include extracting the operational constraints from the communication and evaluating each operational constraint against stored operational parameters of the telecommunications service provider. The method can include modifying the communication based the evaluation of each operational constraint and transmitting the modified communication along a call route.

### CROSS-REFERENCE TO RELATED APPLICATIONS

This application claims the benefit of and the priority to U.S. Provisional Patent Application No. 63/806,811 filed May 16, 2025 entitled “CRYPTOGRAPHICALLY-AUTHENTICATED OPERATIONAL CONSTRAINTS FOR TELEPHONE CALLS,” the entire disclosure of which is hereby incorporated by reference, for all purposes, as if fully set forth herein.

### TECHNICAL FIELD

The present disclosure relates generally to delivering telephone calls. More specifically, but not by way of limitation, this disclosure relates to intelligently delivering telephone calls with cryptographically-authenticated operational constraints.

### BACKGROUND

Transmission of telephone calls over a voice telecommunications network has long been used as a mechanism for enterprises to connect and have meaningful engagement with people. More recently, automated telephone calls (“robocalls”) have been used by entities to reach large numbers of people about particular information, such as campaign advertisements or commercial solicitations. Unfortunately, due to the ease of use and low financial cost of this mechanism, it has been utilized by bad actors who wish to scam or otherwise deceive people into engaging with them. This has resulted in the number of malicious robocalls skyrocketing, with billions of malicious robocalls being made each month. Telecommunication service providers and regulators have attempted to curb the amount of malicious robocalls but have met with little success.

### SUMMARY

Examples of the present disclosure relate to intelligently delivering telephone calls with cryptographically-authenticated operational constraints. One example of the present disclosure includes a method implemented by one or more processors associated with a telecommunications service provider. The method can include receiving, by the one or more processors, a communication associated with a caller requesting to make a telephone call to a recipient. The communication includes a Session Initiation Protocol (SIP) invite including a JavaScript Object Notation (JSON) web token having a payload, where one or more operational constraints associated with the telephone call are encoded into the payload prior to SIP establishment. The method can also include extracting, by the one or more processors, the one or more operational constraints from the payload of the JSON web token. Each operational constraint of the one or more operational constraints can include respective characteristics for transmitting the telephone call. The method can also include evaluating, by the one or more processors, each operational constraint of the one or more operational constraints against one or more stored operational parameters of the telecommunications service provider. The method can also include modifying, by the one or more processors, the communication based the evaluation of each operational constraint and in accordance with the respective characteristics associated with the operational constraint to thereby produce a modified communication. The method can also include transmitting, by the one or more processors, the modified communication along a call route.

In some aspects, the method can also include authenticating, by the telecommunications service provider, the one or more operational constraints based on a cryptographic signature of the SIP invite associated with the caller.

In some aspects, an operational constraint of the one or more stored operational constraints comprises an instruction for the telecommunications service provider to include display information associated with the caller in the communication for display on an end user device of the recipient. In addition, the display information can include a font type, a font size, a font pitch, a font contrast ratio, a font color, a background color, or any combination thereof. In these examples, an operational constraint of the one or more operational constraints comprises an instruction for the telecommunications service provider to include identity information associated with the caller in the communication for display on an end user device of the recipient, where the communication is modified to include the identity information based on an operational parameter of the telecommunications service provider indicating that the telecommunications service provider is capable of satisfying the operational constraint.

In some aspects, an operational constraint of the one or more operational constraints comprises an instruction for the telecommunications service provider to include reasoning information associated with the caller in the communication for display on an end user device of the recipient, where the reasoning information comprises a name of the caller, a reason for calling, a font characteristic, or any combination thereof.

In some aspects, an operational constraint of the one or more operational constraints comprises an instruction for the telecommunications service provider to include image information associated with the caller in the communication for display on an end user device of the recipient, where the image information comprises a reference to a location of an image associated with the caller, a file type associated with the image, a file size associated with the image, an aspect ratio associated with the image, a color depth associated with the image, or any combination thereof. In these examples, the reference comprises a Uniform Resource Locator (URL) identifying the location of an image file associated with the image, and the method can also include accessing, by the one or more processors, the URL, downloading, by the one or more processors, the image file, and inserting, the one or more processors, the image into the communication for display on an end user device of the recipient.

In some aspects, an operational constraint of the one or more operational constraints defines a maximum transaction amount for placing the telephone call, and where an operational parameter of the one or more operational parameters of the telecommunications service provider defines a minimum transaction amount for accepting the telephone call. In these examples, the method can include declining, by the one or more processors, to transmit the communication along the call route in response to determining that the maximum transaction amount for placing the telephone call is less than the minimum transaction amount for accepting the telephone call. Alternatively, the method can include transmitting, by the one or more processors, the communication along the call route in response to determining that the maximum transaction amount for placing the telephone call is greater than or equal to the minimum transaction amount for accepting the telephone call.

In some aspects, the call route begins with the caller, ends with the recipient, and comprises a plurality of telecommunications service providers, where the telecommunications service provider immediately precedes the recipient in the call route.

Another example of the present disclosure includes a system associated with a telecommunications service provider having one or more processors. The system also includes one or more memories including instructions executable by the one or more processors. The instructions can cause the one or more processors to receive a communication associated with a caller requesting to make a telephone call to a recipient, where the communication includes a Session Initiation Protocol (SIP) invite including a JavaScript Object Notation (JSON) web token having a payload, and where one or more operational constraints associated with the telephone call are encoded into the payload prior to SIP establishment. The system can also extract the one or more operational constraints from the payload of the JSON web token, where each operational constraint of the one or more operational constraints comprises respective characteristics for transmitting the telephone call. The system can also evaluate each operational constraint of the one or more operational constraints against one or more stored operational parameters of the telecommunications service provider. The system can also modify the communication based the evaluation of each operational constraint and in accordance with the respective characteristics associated with the operational constraint to thereby produce a modified communication. The system can also transmit the modified communication along a call route.

Yet another example of the present disclosure includes a non-transitory computer-readable medium comprising program code that is executable by one or more processors to cause the one or more processors to receive a communication associated with a caller requesting to make a telephone call to a recipient, where the communication includes a Session Initiation Protocol (SIP) invite including a JavaScript Object Notation (JSON) web token having a payload, and where one or more operational constraints associated with the telephone call are encoded into the payload prior to SIP establishment; extract the one or more operational constraints from the payload of the JSON web token, where each operational constraint of the one or more operational constraints comprises respective characteristics for transmitting the telephone call; evaluate each operational constraint of the one or more operational constraints against one or more stored operational parameters of the telecommunications service provider; modify the communication based the evaluation of each operational constraint and in accordance with the respective characteristics associated with the operational constraint to thereby produce a modified communication; and transmit the modified communication along a call route.

Various other examples are described herein, including methods, systems, non-transitory computer-readable storage media storing programs, code, or instructions executable by one or more processors and the like. These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

Aspects and features of the various examples are described below with reference to the accompanying drawings, in which:

FIG. 1 is a block diagram of an example network environment suitable for intelligently delivering telephone calls with cryptographically-authenticated operational constraints, according to some aspects of the present disclosure;

FIG. 2 is a sequence diagram of an example of a process for intelligently delivering telephone calls with cryptographically-authenticated operational constraints, according to some aspects of the present disclosure;

FIG. 3 is a flowchart of an example of a process for intelligently delivering telephone calls with cryptographically-authenticated operational constraints, according to some aspects of the present disclosure;

FIG. 4 is a flowchart of an example of a process for intelligently delivering telephone calls with cryptographically-authenticated operational constraints, according to some aspects of the present disclosure;

FIG. 5 is a block diagram of an example of a computing system for implementing some aspects of the present disclosure; and

FIGS. 6A-6B is an example JSON web token including cryptographically-authenticated operational constraints, according to some aspects of the present disclosure.

### DETAILED DESCRIPTION

Reference will now be made in detail to various and alternative illustrative examples and to the accompanying drawings. Each example is provided by way of explanation and not as a limitation. It will be apparent to those skilled in the art that modifications and variations may be made. For instance, features illustrated or described as part of one example may be used in another example to yield a still further example. Thus, it is intended that this disclosure includes modifications and variations as come within the scope of the appended claims and their equivalents.

As used herein, the terms “a,” “an,” and “the” can refer to one or more unless specifically noted otherwise. And the term “or” is not to be construed as identifying mutually exclusive options. For example, the phrase “X contains A or B” can mean that X contains A and not B, X contains B and not A, or X contains both A and B. That is, the term “or” is used to mean “and/or” unless explicitly indicated to refer to alternatives only or the alternatives are mutually exclusive.

### Illustrative Example of Intelligently Delivering Telephone Calls With Cryptographically-Authenticated Operational Constraints

Examples of the present disclosure relate to intelligently delivering telephone calls with cryptographically-authenticated operational constraints. More specifically, prior to telephone call establishment between a caller and a recipient, the caller can insert information into the telephone call, where the information defines desired characteristics/traits for the telephone call including how the telephone call should be processed and what information to display on a device associated with a recipient. Inclusion of the information enables participants to the telephone call (including recipients and telecommunication service providers) to agree on a set of compatible media types as a part of telephone call handling and prior to establishment of the telephone call session. A telecommunication service provider can then receive the telephone call, extract the information defining the desired characteristics/traits for the telephone call, and modify and transmit the telephone call to the intended recipient based on the desired characteristics/traits.

One illustrative example of the present disclosure includes a telecommunications service provider that receives a communication associated with a call request from a caller to a recipient. The telecommunications service provider is one of many telecommunications service providers positioned along a call route extending from the caller to the recipient. In this illustrative example, the telecommunications service provider immediately precedes the recipient in the call route and is referred to as a “terminating telecommunications service provider” (TTSP).

The communication received by the TTSP includes a SIP invite. The SIP invite is a message used to start a communication session between participants over the internet. The SIP invite can include a JavaScript Object Notation (JSON) web token, such as a personal assertion token (e.g., a PASSporT). The PASSporT is a token for conveying cryptographically signed information about the sender (e.g., the caller) to the recipient of the PASSporT. The JSON web token, in turn, can have a payload. In this illustrative example, “operational constraints” are inserted into the JSON web token. These operational constraints can be included in the JSON web token in addition to other rich call data (RCD). The JSON web token, and thus the operational constraints therein, are then cryptographically authenticated by virtue of pre-SIP establishment encoding on a device associated with the caller. More specifically, the JSON web token (and therefore the operational constraints therein) is an input into a cryptographic hash and digital signature algorithm which, for example, may be provided as part of the Secure Telephone Identity Revisited (STIR) and Signature-based Handling of Asserted Information Using Token (SHAKEN) protocols and procedures. STIR/SHAKEN enables telephone calls traveling through interconnected phone networks to be “signed” as legitimate and authenticate by telecommunications systems before reaching the end recipient. STIR/SHAKEN digitally validates the handoff of phone calls passing through the complex web of networks, allowing the phone company of the recipient receiving the call to verify that a call is in fact from the number displayed on Caller ID. By encoding the JSON web token, when the JSON web token is eventually verified by the TTSP, it inherently means that the operational constraints therein can also be verified. This verification can allow both the call recipient and the TTSP to confirm that the operational constraints were provided by the caller. It can also allow the caller to confirm that the operational constraints that were ultimately received by the TTSP were the ones intended. This can serve as an immutable record of intent and also help prevent a malicious actor from intervening to manipulate the operational constraints.

The specifics of the operational constraints are described in more detail below, however, in general, the operational constraints may be encoded (e.g., inserted) into the JSON web token as a JSON object. Each operational constraint may include a set of key-value pairs, where the values may be arrays, objects, numbers, strings, Boolean, or Null. In the case where the JSON web token is a PASSporT, the operational constraints can be nested within the RCD data object of the SHAKEN or RCD PASSporT payload. The operational constraints may include different types of claims such as a name, display information, a reason for calling, or amount where the caller intends for the TTSP to evaluate the operational constraints and handle the processing and transmittal of the telephone call in accordance with the desired characteristics for the telephone call as specified by the operational constraints.

Continuing with the illustrative example, the telecommunications service provider in receipt of the communication evaluates the contents of the communication and extracts the operational constraints from the payload of the JSON web token. The telecommunications service provider then evaluates each operational constraints against stored operational parameters of the telecommunications service provider. That is, the telecommunications service provider evaluates the operational constraints and determines whether the telecommunications service provider has the capability of handling the telephone call in accordance with the desired characteristics for the telephone call as specified by the operational constraints, whether a condition of the operational constraints is satisfied, or how the telecommunications service provider should otherwise handle the telephone call. Based on a result of the telecommunications service provider's evaluation of the operational constraints against the operational parameters of the telecommunications service provider, the telecommunications service provider modifies the communication in accordance with one or more of the operational constraints to produce a modified communication. Then, the telecommunications service provider transmits the modified communication along a call route to the recipient.

Numerous benefits are achieved by way of the present disclosure over conventional techniques for automated caller verification and branded call display. For example, the operational constraints enable a caller to insert more information into telephone call communications including their name, display imaging, reason for calling, etc. Additionally, as noted above, such claims are cryptographically authenticated by virtue of the operational constraints being an input into the cryptographic hash and digital signature algorithm of the JSON web token. Thus, telecommunication service providers can perform a more robust verification process of the caller given the inclusion of more authenticated information as compared to conventional verification technologies that do not include operational constraints. This can help curb the amount of robocalls, spam, and fraud received by call recipients as telecommunication service providers can more effectively screen out spam calls and transmit authenticated calls. In addition, by virtue of the telecommunication service provider modifying the communication associated with the telephone call, additional identity information can be passed on to recipients of the telephone calls so that they can better evaluate and verify caller identity on their end. Moreover, such techniques and inclusion of operational constraints within the JSON web token payload can easily be integrated into pre-existing authentication techniques (e.g., STIR/SHAKEN) currently used by telecommunication service providers, thereby enabling efficient implementation without large changes to existing telecommunications infrastructure.

The description of the illustrative example above is provided merely as an example, not to limit or define the limits of the present subject matter. Various other examples are described herein and variations of such examples would be understood by one of skill in the art. Advantages provided by various examples may be further understood by examining this specification and/or by practicing one or more examples of the claimed subject matter.

### Illustrative Systems and Methods for Intelligently Delivering Telephone Calls with Cryptographically-Authenticated Operational Constraints

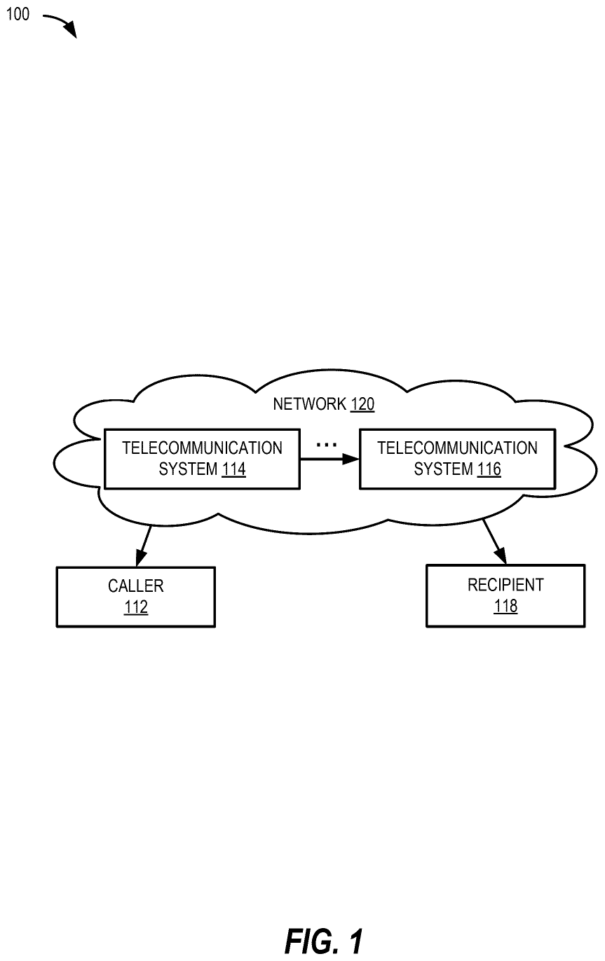

Turning now to the figures, FIG. 1 is a block diagram of an example network environment 100 suitable for intelligently delivering telephone calls with cryptographically-authenticated operational constraints, according to some aspects of the present disclosure. As shown in FIG. 1, network environment 100 includes a caller 112 and a recipient 118. The term “caller” may refer to a calling entity and/or their user equipment, such as their mobile phone or other telephonic device, used to initiate a telephone call. Similarly, the term “recipient” may refer to any called entity and/or their user equipment, such as their mobile phone or other telephonic device, used to receive a telephone call.

Also included in the network environment 100 is telecommunication system 114 and telecommunication system 116 hosted on network 120. As a telephone call traverses through the voice telecommunications network from a caller 112 to a recipient 118, the telephone call may “hop” to numerous different telecommunication systems along a call route as it is transmitted to its end destination. Although only two telecommunication systems are illustrated by FIG. 1, the network environment 100 can include any number of telecommunication systems, where each of these telecommunication systems can be conceptually positioned between telecommunication system 114 and telecommunication 116, such that the call request is transmitted starting at telecommunication system 114, hops to one or more intermediate telecommunications service providers, and is received by telecommunication system 116, where it can then be transmitted to the recipient 118. Additionally, each telecommunication system that is positioned along the call route can correspond to a telecommunications service provider and house the physical infrastructure for routing telephone calls between callers and recipients. For example, the telecommunication systems 114 and 116 can coupled together via network 120 and each telecommunication system can be public switched telephone networks (PSTN) and/or have respective base stations, switches, local exchanges, and core networks for transmitting telephone calls between callers and recipients.

In some examples, telecommunication system 114 can be referred to as an originating telecommunications service provider and telecommunication system 116 can be referred to as a terminating telecommunications service provider. An originating telecommunications service provider can be responsible for receiving call requests from their customers and transmitting them along a call route to the intended recipient. The originating telephone service provider can be the first telecommunications service provider in the chain of telecommunications service providers along the end-to-end call path. Similarly, the terminating telecommunications service provider can be the final telecommunications service provider in the chain of telecommunications service providers along the end-to-end call path. The terminating telecommunications service provider can be responsible for transmitting the call request to the intended recipient.

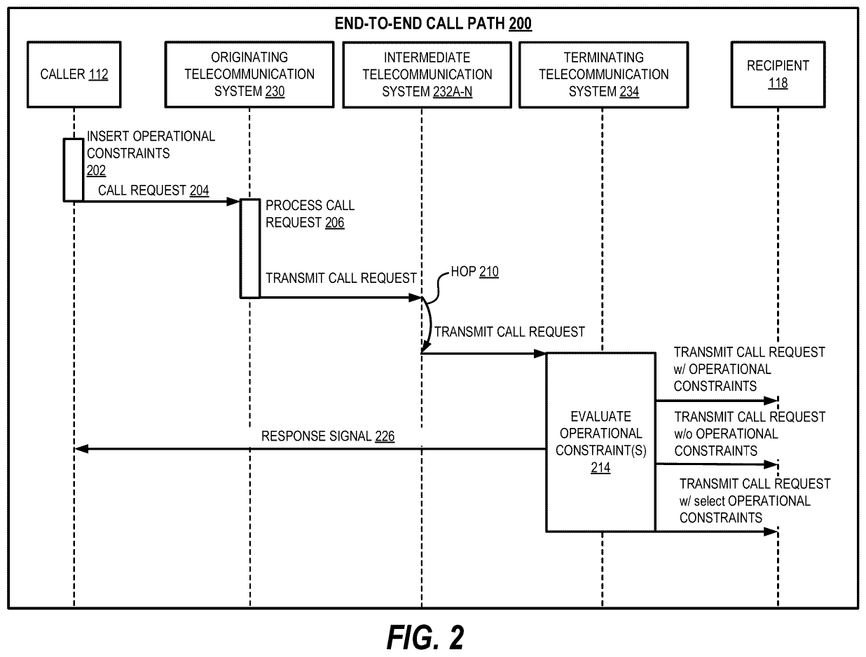

FIG. 2 is a sequence diagram of an example of a process for intelligently delivering telephone calls with cryptographically-authenticated operational constraints, according to some aspects of the present disclosure. FIG. 2 illustrates the end-to-end call path 200 for a caller 112 placing a telephone call to a recipient 118. Similar to the call path described above with respect to FIG. 1, the end-to-end call path 200 includes a number of telecommunication systems conceptually positioned between the caller 112 and the recipient 118 such that the call request 204 transmitted by the caller 112 traverses through and is processed by the telecommunications systems in route to the recipient 118. As shown in FIG. 2, the end-to-end call path 200 includes originating telecommunication system 230 and terminating telecommunication system 234. Originating telecommunication system 230 can represent the first telecommunication system in the end-to-end call path 200 and terminating telecommunication system 234 can represent the last telecommunication system in the end-to-end call path 200. Between originating telecommunication system 230 and terminating telecommunication system 234 can be one or more intermediate telecommunication systems 232A-N. As shown in FIG. 2, the call request 204 may originate with the originating telecommunication system 230, undergo a number of hops, as illustrated by hop 210 at one or more intermediate telecommunication systems 232A-N, and terminate at terminating telecommunication system 234 before transmittal to recipient 118.

Beginning at the left of end-to-end call path 200, caller 112 can initiate a telephone call via call request 204. The call request may include a SIP invite having a SIP header into which the caller 112 can insert the caller telephone number, among other information. The SIP invite is an invitation to a participant (e.g., recipient 118) to communicate with the sender of the SIP invite (e.g., the caller 112). As previously discussed, the SIP invite header can further include RCD structured, for example, as a JSON object that is inserted into the SIP invite header.

The caller 112 (e.g., a device associated with the caller 112) can insert additional information into the call request 204, such as operational constraints 202. More specifically, the operational constraints may be inserted into the payload of the JSON web token associated with the call request 204. The caller 112 can insert (e.g., a device associated with the caller 112 can encode) the operational constraints into the JSON web token before the SIP session has been fully established. Because the operational constraints become part of the JSON web token, downstream processes that evaluate the JSON web token may inherently also evaluate the operational constraints. For example, the operational constraints can inherently be a part of the input to a cryptographic hash and digital signature algorithm, which is applied to the JSON web token as a whole, for example in accordance with the STIR/SHAKEN protocols and procedures. Because the operational constraints are encoded along with the rest of the data in the JSON web token, successful verification of the digital signatures attached to the JSON web token payload can inherently provide proof of authenticity of the operational constraints therein. The operational constraints are evaluated by a computing device (e.g., a verification server) associated with terminating telecommunication system 234.

The operational constraints may be formatted as a JSON object specified in the JSON web token. The JSON object can define the operational constraints as a set of key-value pairs, where the values may be arrays, objects, numbers, strings, Boolean, or Null. The operational constraints include different classes and different types. In one implementation, the classes of operational constraints are mandatory and optional. In the call request 204, either class of operational constraints may be included, and in some examples, the call request 204 may include both classes of operational constraints. A mandatory operational constraint is an operational constraint claim that must be implemented by the terminating telecommunication system 234 for the call to proceed with RCD, whereas an optional operational constraint does not need to be implemented by the terminating telecommunication system 234 for the call to proceed with RCD.

In addition to classes of operational constraints, the caller has the option to insert a variety of types of operational constraints into the call request 204. A first type of operational constraint can be a “name” claim. The name operational constraint can be a string and is associated with a display name of the caller 112. The name operational constraint provides desired characteristics/traits for displaying identity information, such as a name of the caller, on a device associated with the recipient 118. The name operational constraint object can specify a font type (e.g., of JSON string data type), font name (e.g., of JSON string data type), font size (e.g., of JSON number data type), pitch (e.g., of JSON number data type), contrast (e.g., a two element array of JSON number data type), color (e.g., of JSON string data type), and background color (e.g., of JSON string data type) providing desired characteristics to the terminating telecommunication system 234 as to how to display the name operational constraint on a device associated with recipient 118. In some implementations, the name operational constraint may be associated with identity information of the caller 112.

A second type of operational constraint can be a “reason for calling” operational constraint. The reason for calling operational constraint can be a string associated with a message to be displayed on the recipient 118 device during alerting and ringing and prior to session establishment. In some examples, the reason for calling operational constraint can have a default class of optional. In other words, if the terminating telecommunication system 234 supports insertion of the RCD associated with the reason for calling operational constraint, the terminating telecommunication system 234 should include the data. Otherwise, if the terminating telecommunication system 234 should ignore the reason for calling operational constraint. The reason for calling operational constraint provides desired characteristics/traits for displaying a reason for calling associated with the call request on a device associated with the recipient 118 Similar to the name operational constraint, the reason for calling operational constraint can specify a font type (e.g., of JSON string data type), font name (e.g., of JSON string data type), font size (e.g., of JSON number data type), pitch (e.g., of JSON number data type), contrast (e.g., a two element array of JSON number data type), color (e.g., of JSON string data type), and background color (e.g., of JSON string data type) providing desired characteristics to the terminating telecommunication system 234 as to how to display the reason for calling operational constraint on a device associated with recipient 118. In some examples, the specified font type, font name, font size, etc. may be the same or different from the name ROC claim specifications.

A third type of operational constraint can be a “display information” operational constraint. The display information operational constraint can be a reference locator that references the location of an image file. In some examples, the reference locator can be a Uniform Reference Locator (URL). In some implementations, the call request 204 can include more than one display information operational constraint pointing to more than image files. The display information operational constraint can specify a file type associated with the image (e.g., a string such as “bmp” for bitmap file types), a file size (e.g., a one dimensional array with two elements of type number for a minimum and maximum file size in octets), dimension information (e.g., a two dimensional array with two elements of type number for a minimum and maximum number of rows and columns of pixels), an aspect ratio (e.g., a one dimensional array with two elements of type number representing an aspect ratio in the x-and y-directions), and a color depth (e.g., a one dimensional array with two elements of type integer representing minimum and maximum bit depth). The display information operational constraint provides desired characteristics to the terminating telecommunication system 234 as to how to display an image file on a device associated with the recipient 118.

A fourth type of operational constraint can be an “amount” operational constraint. The amount operational constraint can provide desired characteristics/traits regarding a maximum transaction amount the caller 112 is willing to allocate to place the call request 204 to the recipient 118. In other words, call request 204 including RCD may incur a cost that is charged to the caller 112. Thus, the amount operational constraint can specify a maximum limit the caller 112 is willing to spend. The amount operational constraint can further specify a currency type (e.g., a JSON string representing a currency type), a limit (e.g., a floating point value greater than or equal to zero), and a type (e.g., of class optional comprising a JSON string with a user defined value). As mentioned, the values in the “currency” and “limit” claims of the amount operational constraint indicate to the recipient 118 and/or a terminating telecommunication system 234 that the caller 112 is willing to pay for the display of operational constraints (or other forms of RCD) associated with the call request 204 up to or equal the value defined by the currency, limit, and type objects specified in the amount operational constraint.

After inserting the operational constraints, the call request 204 is received by originating telecommunication system 230. In some implementations, the originating telecommunication system 230 can perform further processing on the call request, as shown by the process call request 206 block in the end-to-end call path 200. For instance, in some examples, the originating telecommunication system 230 can further modify the call request 204 by inserting their own operational constraints. After processing the call request 204, the originating telecommunication system 230 transmits the call request (e.g., block 208) to intermediate telecommunication systems 232A-N. As previously described, the call request 204 may undergo a number of hops (e.g., hop 210) as the call request 204 traverses through the network. Ultimately, the call request 204 is received (e.g., block 212) by terminating telecommunication system 234.

The terminating telecommunication system 234 receives the call request 204 and evaluates the operational constraints 214 in the call request 204. It will be appreciated that the terminating telecommunication system 234 is preconfigured with operational parameters. The operational parameters may be predefined by an administrator of the terminating telecommunication system 234. The operational parameters of the terminating telecommunication system 234 may define one or more capabilities supported by the infrastructure of the terminating telecommunication system 234. For example, the one or more capabilities may define whether the terminating telecommunication system 234 has the appropriate infrastructure to handle call requests including operational constraints and whether the terminating telecommunication system 234 has the appropriate infrastructure to properly modify such call requests in accordance with the desired characteristics for the call request 204 provided in the operational constraint claims.

For example, if all the operational constraints are supported, the terminating telecommunication system 234 modifies the call request 204 in accordance with the desired characteristics for the call request 204 as specified in the operational constraints and transmits the modified call request to the recipient 118. According to a particular example, in evaluating the call request 204 and the operational constraints, the terminating telecommunication system 234 may determine that the operational parameters of the terminating telecommunication system 234 supports the operational constraints (e.g., supports one or more of the name operational constraint, reason for calling operational constraint, display information operational constraint, amount operational constraint, etc.). Then, the terminating telecommunication system 234 can modify the call request and transmit the call request to the recipient 118, where the recipient 118 can view the incoming call request with the respective RCD and operational constraint data displayed.

In another example, if the operational constraints are not supported, the terminating telecommunication system 234 can transmit the call request 204 without the operational constraints. In some implementations, the terminating telecommunication system 234 can also transmit a response signal 226 to the caller 112 indicating that the call request 204 was transmitted without the desired operational constraints. In some implementations, the terminating telecommunication system 234 can deny the call request 204 altogether, where the call request 204 may be denied by virtue of the operational constraints not being satisfied for a variety of reasons. For instance, if the call request 204 includes an amount operational constraint and the limit constraint defined in the amount operational constraint is below a threshold amount set by the terminating telecommunication system 234 (e.g., the terminating telecommunication system 234 is charging more than the caller 112 the limit constraint defined in the amount operational constraint), then the terminating telecommunication system 234 can deny the call request 204.

In another example, if an operational constraint in the call request 204 is of class “mandatory” but the terminating telecommunication system 234 does not have the requisite operational parameters to the mandatory operational constraint, the terminating telecommunication system 234 can deliver the call request 204 with all operational constraints stripped out and/or ignored. Whether the terminating telecommunication system 234 denies the call request 204 responsive to evaluation of the operational constraints may be specified in the operational constraint itself. More specifically, a mandatory operational constraint may specify that the call request 204 must be delivered with the mandatory operational constraint, otherwise, the call should be denied.

In another example, the terminating telecommunication system 234 may proceed to deliver the call request 204 with select operational constraints. More specifically, the terminating telecommunication system 234 may deliver the call request 204 including the operational constraints the terminating telecommunication system 234 supports while ignoring the rest.

In one example, and in the context of mandatory and optional operational constraints, if a call request 204 includes only mandatory operational constraints and the terminating telecommunication system 234 supports delivery of telephone calls including the mandatory operational constraints, then the call request 204 can proceed to the recipient 118 including all mandatory operational constraints.

In another example, if a call request 204 includes only mandatory operational constraints and the terminating telecommunication system 234 does not support one or more of the included mandatory operational constraints, then the call request 204 can proceed to the recipient 118 with all the mandatory operational constraints ignored by the terminating telecommunication system 234 (e.g., the call request 204 is delivered without any RCD). Similarly, if a call request 204 includes both mandatory operational constraints and optional operational constraints and the terminating telecommunication system 234 does not support one or more of the included mandatory operational constraints, then the call request 204 can proceed to the recipient 118 with the mandatory operational constraints and the optional operational constraints ignored by the terminating telecommunication system 234 (e.g., the call request 204 is delivered without any RCD).

In another example, if a call request 204 includes both mandatory operational constraints and optional operational constraints and the terminating telecommunication system 234 supports all the included mandatory operational constraints but supports some or none of the included optional operational constraints, then the call request 204 can proceed to the recipient 118 with all mandatory operational constraints and only the supported optional operational constraints (e.g., the unsupported optional operational constraints are ignored by the terminating telecommunication system 234).

In another example, if a call request 204 includes only optional operational constraints and the terminating telecommunication system 234 supports all the included optional operational constraints, then the call request 204 can proceed to the recipient 118 including all the optional operational constraints.

In another example, if a call request 204 includes only optional operational constraints and the terminating telecommunication system 234 does not support one or more of the included optional operational constraints, then the call request 204 can proceed to the recipient 118 based on the optional operational constraints that the terminating telecommunication system 234 supports with the optional operational constraints that the terminating telecommunication system 234 does not support ignored by the terminating telecommunication system 234. As new types of operational constraints are developed, a terminating telecommunication system may only process the optional operational constraints it understands and ignore the rest.

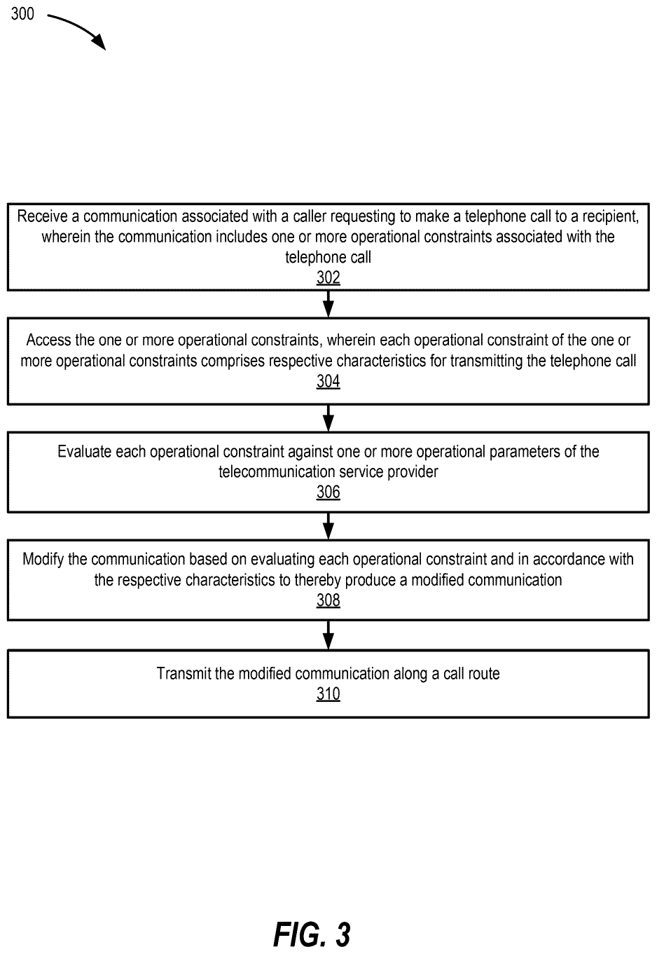

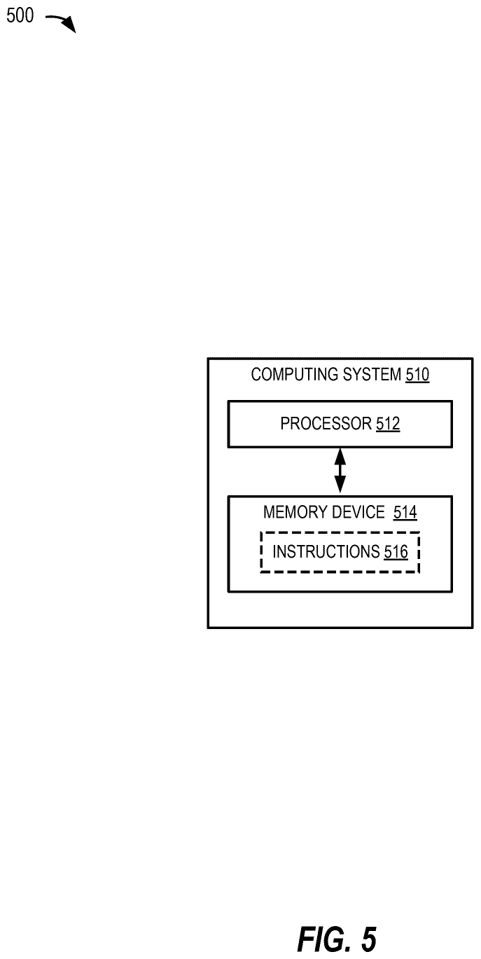

FIG. 3 is a flowchart of an example of a process 300 for intelligently delivering telephone calls with cryptographically-authenticated operational constraints, according to some aspects of the present disclosure. The process 300 will be described with respect to the terminating telecommunication system 234 and the end-to-end call path 200 shown in FIG. 2; however, any suitable system or platform according to this disclosure may be employed, including the example telecommunication systems 114, 116 of FIG. 1 or the computing system 510 shown in FIG. 5. Additionally, process 300 is provided in the order shown, but other orders or additional steps may be provided.

At block 302, terminating telecommunication system 234 can receive a communication associated with a caller requesting to make a telephone call to a recipient. The communication can include one or more operational constraints associated with the telephone call. As described with respect to FIG. 2, the communication can include a variety of types of operational constraints, such as name operational constraints, reason for calling operational constraints, identity information operational constraints, amount operational constraints, and so on. In some implementations, the communication can include a JSON web token, such as a PASSporT, having a payload where the operational constraints are encapsulated therewithin. Because the operational constraints are included within the payload of the JSON web token, the operational constraints may subsequently be input into the cryptographic hash and digital signature algorithm of the JSON web token, for example as provided by the STIR/SHAKEN protocols and procedures. As such, successful verification of the digital signatures attached to the JSON web token payload provides proof of authenticity of the operational constraints, since the operational constraints were encoded by the signer of the JSON web token. By enabling the inclusion of cryptographically-authenticated operational constraints into telephone call communications, terminating telecommunication systems and recipients can have more confidence as to the identity of the caller thereby enabling a more robust verification process to validate the caller. As a result, this can help curb the amount of robocalls, spam, and fraud received by call recipients.

At block 304, terminating telecommunication system 234 can access the one or more operational constraints encoded in the JSON web token. Each operational constraint can include respective desired characteristics/traits for transmitting the telephone call. As illustrated in FIG. 2, the call request 204 (e.g., the communication) may traverse through the end-to-end call path started with the caller 112, proceeding to the originating telecommunication system 230, traversing through any intermediate telecommunication systems 232A-N, and then being received by terminating telecommunication system 234. The terminating telecommunication system 234 can receive the communication and access the contents within, such as the one or more operational constraints.

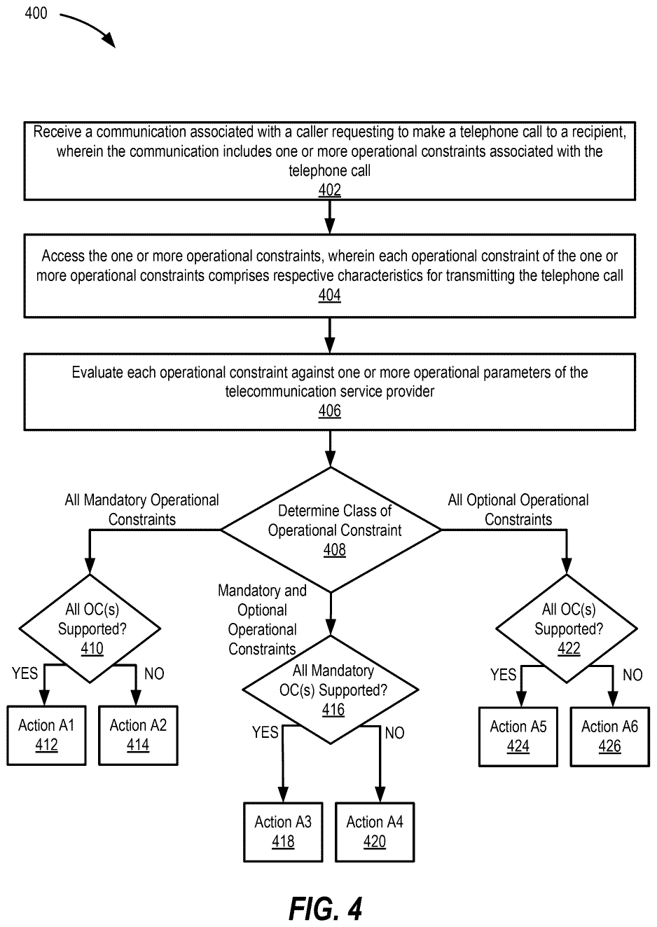

At block 306, terminating telecommunication system 234 can evaluate each operational constraint against one or more operational parameters of the telecommunication communication system 234. The operational parameters of the terminating telecommunication system 234 may define one or more capabilities supported by the infrastructure of the terminating telecommunication system 234. For example, the one or more capabilities may define whether the terminating telecommunication system 234 has the appropriate infrastructure to handle call requests including operational constraints and whether the terminating telecommunication system 234 has the appropriate infrastructure to properly modify such call requests in accordance with the desired characteristics provided in the operational constraints. In some examples, the terminating telecommunication system 234 may support all of the operational constraints in the communication. In some examples, the terminating telecommunication system 234 may support some of the operational constraints in the communication but not others. In some examples, the terminating telecommunication system 234 may support none of the operational constraints in the communication. Additionally, some of the operational constraints may be of a mandatory class and some operational constraints may be of an optional class. Unique handling of operational constraints based on class is discussed in more detail with respect to FIG. 4.

At block 308, terminating telecommunication system 234 can modify the communication based on evaluating each operational constraint and in accordance with the respective desired characteristics to thereby produce a modified communication. More specifically, based on the evaluation of the operational constraints by the terminating telecommunication system 234, the terminating telecommunication system 234 may determine that the operational parameters of the terminating telecommunication system 234 supports the operational constraints or the operational constraints are otherwise satisfied. Responsive to this evaluation, the terminating telecommunication system 234 can modify the communication in accordance with the desired characteristics for the telephone call as defined by the operational constraints to thereby produce the modified communication. For instance, modification of the communication can involve inserting additional metadata into the communication as specified by the operational constraint. For example, if the communication includes an identity information operational constraint that is supported by the terminating telecommunication system 234, the terminating telecommunication system 234 can download the image file via accessing the reference in the identity information operational constraint and insert the image into the communication for display on the recipient device. As another example, if the communication includes a name operational constraint specifying a particular name, font, font size, and font color, the terminating telecommunication system 234 can modify the communication to insert the name data in accordance with the desired characteristics regarding font, font size, and font color for display on the recipient device.

At block 310, terminating telecommunication system 234 can transmit the modified communication along a call route. In some examples, the terminating telecommunication system 234 can immediately precede the recipient 118 in the call route. As such, after evaluation of the communication and generation of the modified communication, the terminating telecommunication system 234 can transmit the modified communication to the recipient 118.

FIG. 4 is a flowchart of an example of a process 400 for intelligently delivering telephone calls with cryptographically-authenticated operational constraints, according to some aspects of the present disclosure. Similar to process 300, process 400 will be described with respect to the terminating telecommunication system 234 and the end-to-end call path 200 shown in FIG. 2; however, any suitable system or platform according to this disclosure may be employed, including the example telecommunication systems 114, 116 of FIG. 1 or the computing system 510 shown in FIG. 5. Additionally, process 400 is provided in the order shown, but other orders or additional steps may be provided.

Process 400 includes many of the steps described above in relation to process 300. Blocks 402-406 are generally performed as discussed above with respect to blocks 302-306 of FIG. 3.

At block 408, terminating telecommunication system 234 can determine the class of operational constraints included in the communication (e.g., mandatory or optional) and process the communication accordingly. As mentioned with respect to FIG. 2, terminating telecommunication system 234 is preconfigured with operational parameters. The operational parameters may be predefined by an administrator of the terminating telecommunication system 234. The operational parameters of the terminating telecommunication system 234 may define one or more capabilities supported by the infrastructure of the terminating telecommunication system 234. As such, the terminating telecommunication system 234 can evaluate operational constraints in the communication to determine how to proceed with the communication.

If all the operational constraints are of class mandatory, then process 400 can proceed to block 410 where terminating telecommunication system 234 evaluates the mandatory operational constraints and determines whether terminating telecommunication system 234 supports call delivery having the included mandatory operational constraints. If all mandatory operational constraints are supported, then process 400 proceeds to block 412 to execute action A1. Action A1 can include modifying the communication based on each mandatory operational constraint to produce a modified communication and transmitting the modified communication along a call route to the recipient. If at least one mandatory operational constraint is not supported, then process 400 proceeds to block 414 to execute action A2. Action A2 can include transmitting the communication along a call route to the recipient without modifying the communication (e.g., all the mandatory operational constraints are ignored by the terminating telecommunication system 234 and the communication is delivered without any RCD).

If the communication includes a combination of mandatory operational constraints and optional operational constraints, then process 400 can proceed to block 416 where terminating telecommunication system 234 evaluate the mandatory operational constraints and determine whether terminating telecommunication system 234 supports call delivery having the included mandatory operational constraints. If all mandatory operational constraints are supported, then process 400 proceeds to block 418 to execute action A3. Action A3 can include modifying the communication based on each mandatory operational constraint as well as the optional operational constraints supported by the terminating telecommunication system 234 (e.g., including the supported optional operational constraints and ignoring the unsupported optional operational constraints) to produce a modified communication and transmitting the modified communication along a call route to the recipient. If at least one mandatory operational constraint is not supported, then process 400 proceeds to block 420 to execute action A4. Action A4 can include similar processing steps as discussed with respect to Action A2 of block 414.

If all the operational constraints are of class optional, then process 400 can proceed to block 422 where terminating telecommunication system 234 evaluates the optional operational constraints and determines whether terminating telecommunication system 234 supports call delivery having the included optional operational constraints. If all optional operational constraints are supported, then process 400 proceeds to block 424 to execute action A5. Action A5 can include modifying the communication based on each optional operational constraint to produce a modified communication and transmitting the modified communication along a call route to the recipient. If at least one optional operational constraint is not supported, then process 400 proceeds to block 426 to execute action A6. Action A6 can include modifying the communication based on each optional operational constraint supported by the terminating telecommunication system 234 (e.g., including the supported optional operational constraints and ignoring the unsupported optional operational constraints) to produce a modified communication and transmitting the modified communication along a call route to the recipient. In any of the above described actions (e.g., Actions A1-A6), responsive to the evaluation and execution of the actions, the terminating telecommunication system 234 may transmit a response signal 226 to the caller 112 indicating which action has been performed.

While the techniques described herein are described in the context of encoding operational constraints into a JSON web token of a SIP invite, it will be appreciated that the disclosed techniques may also be applied to other types of communications than SIP-based communications. The JSON web-token payload objects described herein may be employed in a variety of telecommunications or data interchange protocols to achieve cryptographically-authenticated delivery of operational constraints. For instance, JSON web tokens may be used to encode information in protocols supporting instant messaging, multimedia streaming, and/or other forms of networked communications whereby operational constraints may govern not only call setup and display characteristics, but also session control, resource prioritization, and/or transactional parameters. In such examples, the principles of cryptographic authentication, evaluation of operational constraints against system capabilities, and modification of communications in accordance with those constraints remain applicable, regardless of the underlying signaling protocol. Examples of signaling protocols that may benefit from the techniques described herein may include, but are not limited to, other PASSporT types such as “shaken” PASSporTs, “diversion” PASSporTs, “Resource Priority Header” PASSporTs, and “message” and “response” PASSporTs.

Further, JSON web tokens themselves may be utilized in numerous contexts beyond telephone communications, since JSON web tokens can provide a flexible and secure format for authenticated data interchange. For example, the JSON web tokens described herein may be employed to encode W3C Verifiable Credentials, enabling secure transmission of attested information across diverse platforms. The techniques described herein may also be applied to those other contexts. For instance, the techniques described herein can be applied to protocols implementing selective disclosure or privacy-preserving authentication, such as those specified in RFC 9901 “Selective Disclosure for JSON Web Tokens.” In these and other contexts, operational constraints may be extended to encompass permissions, access control parameters, and/or other user-defined criteria relevant to the particular application environment. Thus, the techniques described herein can be applied in a wide variety of contexts in which operational constraints are cryptographically authenticated and evaluated, whether in telephony, messaging, identity verification, or other domains in which JSON web tokens and similar data structures are employed.

FIG. 5 is a block diagram of an example of a computing system 510 usable to implement some aspects described herein. The computing system 510 includes a processor 512 communicatively coupled with a memory device 514. The processor 512 can include one processor or multiple processors. Non-limiting examples of the processor 512 include a Field-Programmable Gate Array (FPGA), an application-specific integrated circuit (ASIC), or a microprocessor. The processor 512 can execute instructions 516 stored in the memory device 614 to perform operations. In some examples, the instructions 516 can include processor-specific instructions generated by a compiler or an interpreter from code written in any suitable computer-programming language, such as C, C++, C #, etc. For example, the instructions 516 can include the instructions that cause the processor 512 to perform the operations discussed in relation to process 500 of FIG. 5.

The memory device 514 can include one memory device or multiple memory devices. The memory device 514 can be non-volatile and may include any type of memory device that retains stored information when powered off. Non-limiting examples of the memory device 514 include electrically erasable and programmable read-only memory (EEPROM) or flash memory. At least some of the memory device includes a non-transitory computer-readable medium from which the processor 512 can read instructions 516. A computer-readable medium can include electronic, optical, magnetic, or other storage devices capable of providing the processor 512 with computer-readable instructions 516 or other program code. Non-limiting examples of a computer-readable medium include magnetic disk(s), memory chip(s), ROM, random-access memory (RAM), an ASIC, a configured processing device, optical storage, or any other medium from which a computer processing device can read the instructions 516.

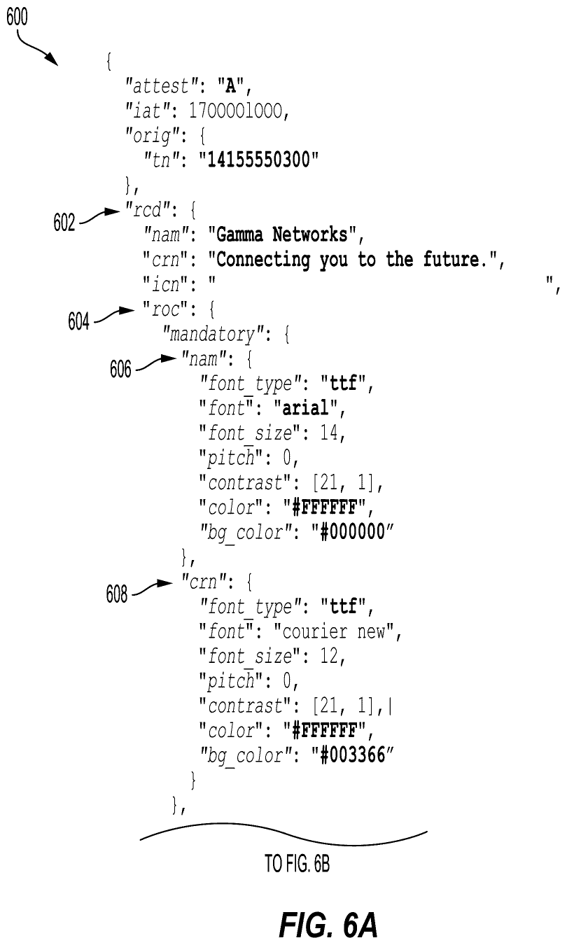

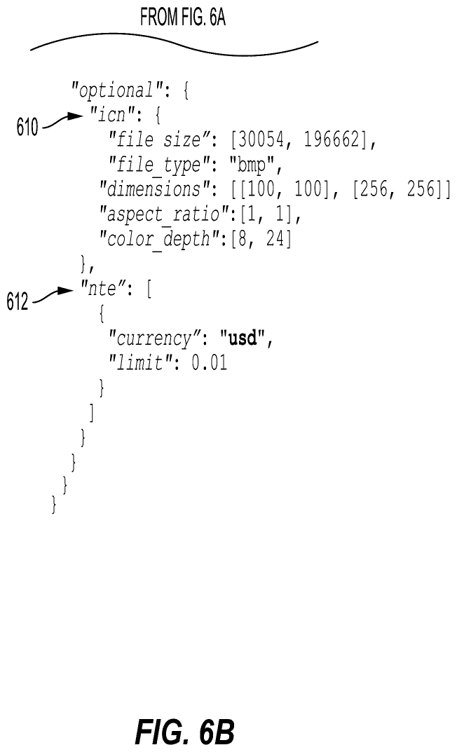

FIGS. 6A-6B is an example JSON web token 600 including cryptographically-authenticated operational constraints, according to some aspects of the present disclosure. As shown in FIGS. 6A-6B, JSON web token 600 can include RCD specifying authenticated caller data associated with the caller such as a name of the caller “Gamma Networks,” a reason for calling “Connecting you to the future,” and an reference to an image location in the form of a URL. JSON web token 600 also includes encoded operational constraints 604 including operational constraints 604 of class mandatory including name operational constraints 606 and reason for calling operational constraints 608. JSON web token 600 also includes encoded operational constraints 604 of claims optional including identity information operational constraints 610 and amount operational constraints 612. Each of the operational constraints 606 include the various fields and desired characteristics/traits for the telephone call as described with respect to FIG. 2. For instance, focusing on the identity information operational constraint 610, the file size field instruction includes instructions specified in a one-dimensional array with two elements of type number for a minimum and maximum file size in octets.

The JSON web token 600 of FIGS. 6A-6B is an example of a PASSporT which may be inserted into the contents of a SIP identity header as part of a telephone call request. More specifically, voice calls signaled using the SIP invite method include various headers or message bodies to allow participants to create sessions carrying session descriptions. Leveraging these SIP technologies, operational constraints 604 can be encapsulated within a JSON web token 600 that may be inserted into the contents of a SIP identity header. Callers (or telecommunication service providers) may modify such headers or message bodies prior to SIP establishment with operational constraints 604 associated with the telephone calls thereby enabling participants to of the telephone call to agree on a set of compatible media types as a part of telephone call handling.

Then, when the telephone call is initiated, cryptographically authenticated digital signatures may be attached to the SIP invite header (e.g., as defined by STIR/SHAKEN protocols and procedures). Thus, the contents of the claims encoded into the contents of the SIP identity header, including the operational constraints 604, are also cryptographically-authenticated because JSON web token 600 will be cryptographically authenticated as part of the telephone call handling and the operational constraints 604 are included within the payload of the JSON web token 600. As a result, the operational constraints 604 can be an input into the cryptographic hash and digital signature algorithm of the JSON web token 600 as provided, for example, by the STIR/SHAKEN protocols and procedures. That is, evaluation of the operational constraints 604 on authenticated caller data precedes session establishment (in contrast with unauthenticated session description protocol (SDP) message bodies used to describe media and other requirements in operation after a SIP session has been established).

A telecommunication service provider can receive the telephone call, verify the authenticity of the operational constraints 604 via verification of the digital signatures in the SIP identity header, and then modify and transmit the telephone call to the intended recipient. As such, successful verification of the digital signatures attached to the JSON web token 600 payload provides proof of authenticity of the operational constraints 604 as the operational constraints 604 were encoded by the same signer of the JSON web token 600.

The forgoing examples are not limited to the precise number and arrangement of telecommunications service providers, computing devices, components, and/or steps described above. Other examples can involve other combinations or arrangement of these elements. Numerous other modifications, adaptations and uses of the techniques described herein will be apparent to those skilled in the art without departing from the scope of the disclosure.

What is claimed is:

1. A method performed by one or more processors associated with a telecommunications service provider, the method comprising:
receiving, by the one or more processors, a communication associated with a caller requesting to make a telephone call to a recipient, wherein the communication includes a JavaScript Object Notation (JSON) web token having a payload, wherein one or more operational constraints associated with the telephone call are encoded into the payload prior to receiving the communication;
extracting, by the one or more processors, the one or more operational constraints from the payload of the JSON web token, wherein each operational constraint of the one or more operational constraints comprises respective characteristics for transmitting the telephone call;
evaluating, by the one or more processors, each operational constraint of the one or more operational constraints against one or more stored operational parameters of the telecommunications service provider;
modifying, by the one or more processors, the communication based the evaluation of each operational constraint and in accordance with the respective characteristics associated with the operational constraint to thereby produce a modified communication; and
transmitting, by the one or more processors, the modified communication along a call route.

2. The method of claim 1, wherein the JSON web token is included in a Session Initiation Protocol (SIP) invite, wherein the method further comprises:
authenticating, by the telecommunications service provider, the one or more operational constraints based on a cryptographic signature of the SIP invite associated with the caller.

3. The method of claim 1, wherein an operational constraint of the one or more stored operational constraints comprises an instruction for the telecommunications service provider to include display information associated with the caller in the communication for display on an end user device of the recipient.

4. The method of claim 3, wherein the display information comprises a font type, a font size, a font pitch, a font contrast ratio, a font color, a background color, or any combination thereof.

5. The method of claim 3, wherein an operational constraint of the one or more operational constraints comprises an instruction for the telecommunications service provider to include identity information associated with the caller in the communication for display on an end user device of the recipient, and wherein the communication is modified to include the identity information based on an operational parameter of the telecommunications service provider indicating that the telecommunications service provider is capable of satisfying the operational constraint.

6. The method of claim 1, wherein an operational constraint of the one or more operational constraints comprises an instruction for the telecommunications service provider to include reasoning information associated with the caller in the communication for display on an end user device of the recipient, wherein the reasoning information comprises a name of the caller, a reason for calling, a font characteristic, or any combination thereof.

7. The method of claim 1, wherein an operational constraint of the one or more operational constraints comprises an instruction for the telecommunications service provider to include image information associated with the caller in the communication for display on an end user device of the recipient, wherein the image information comprises a reference to a location of an image associated with the caller, a file type associated with the image, a file size associated with the image, an aspect ratio associated with the image, a color depth associated with the image, or any combination thereof.

8. The method of claim 7, wherein the reference comprises a Uniform Resource Locator (URL) identifying the location of an image file associated with the image, wherein the method further comprises:
accessing, by the one or more processors, the URL;
downloading, by the one or more processors, the image file; and
inserting, the one or more processors, the image into the communication for display on an end user device of the recipient.

9. The method of claim 1, wherein an operational constraint of the one or more operational constraints defines a maximum transaction amount for placing the telephone call, and wherein an operational parameter of the one or more operational parameters of the telecommunications service provider defines a minimum transaction amount for accepting the telephone call.

10. The method of claim 9, further comprising:
transmitting the modified communication along the call route in response to determining that the maximum transaction amount for placing the telephone call is greater than or equal to the minimum transaction amount for accepting the telephone call.

11. The method of claim 1, wherein the call route begins with the caller, ends with the recipient, and comprises a plurality of telecommunications service providers, wherein the telecommunications service provider immediately precedes the recipient in the call route.

12. A system associated with a telecommunications service provider comprising:
one or more processors; and
one or more memories including instructions executable by the one or more processors to cause the one or more processors to:
receive a communication associated with a caller requesting to make a telephone call to a recipient, wherein the communication a JavaScript Object Notation (JSON) web token having a payload, wherein one or more operational constraints associated with the telephone call are encoded into the payload prior to receiving the communication;
extract the one or more operational constraints from the payload of the JSON web token, wherein each operational constraint of the one or more operational constraints comprises respective characteristics for transmitting the telephone call;
evaluate each operational constraint of the one or more operational constraints against one or more stored operational parameters of the telecommunications service provider;
modify the communication based the evaluation of each operational constraint and in accordance with the respective characteristics associated with the operational constraint to thereby produce a modified communication; and
transmit the modified communication along a call route.

13. The system of claim 12, wherein the communication comprises a Session Initiation Protocol (SIP) invite which includes the JSON web token, wherein the call route begins with the caller, ends with the recipient, and comprises a plurality of telecommunications service providers, wherein the telecommunications service provider immediately precedes the recipient in the call route, wherein the processor is further configured to:
authenticate the one or more operational constraints based on a cryptographic signature of the SIP invite associated with the caller.

14. The system of claim 12, wherein an operational constraint of the one or more stored operational constraints comprises an instruction for the telecommunications service provider to include display information associated with the caller in the communication for display on an end user device of the recipient, wherein the display information comprises a font type, a font size, a font pitch, a font contrast ratio, a font color, a background color, or any combination thereof.

15. The system of claim 14, wherein an operational constraint of the one or more operational constraints comprises an instruction for the telecommunications service provider to include identity information associated with the caller in the communication for display on an end user device of the recipient, and wherein the communication is modified to include the identity information based on an operational parameter of the telecommunications service provider indicating that the system is capable of satisfying the operational constraint.

16. The system of claim 12, wherein an operational constraint of the one or more operational constraints comprises an instruction for the telecommunications service provider to include image information associated with the caller in the communication for display on an end user device of the recipient, wherein the image information comprises a reference to a location of an image associated with the caller, a file type associated with the image, a file size associated with the image, an aspect ratio associated with the image, a color depth associated with the image, or any combination thereof, wherein the reference comprises a Uniform Resource Locator (URL) identifying the location of an image file associated with the image, wherein the one or more processors is further configured to:
access the URL;
download the image file; and
insert the image into the communication for display on an end user device of the recipient.

17. The system of claim 12, wherein the one or more processors is further configured to:
determine that the telecommunications service provider is incompatible with the one or more operational constraints; and
transmit, responsive to determining incompatibility, the communication along the call route and in accordance with a default mode, wherein in the default mode the communication is transmitted to the recipient along the call route without modification.

18. The system of claim 12, wherein an operational constraint of the one or more operational constraints defines a maximum transaction amount for placing the telephone call, and wherein an operational parameter of the one or more operational parameters of the telecommunications service provider defines a minimum transaction amount for accepting the telephone call, wherein the one or more processors is further configured to:
decline to modify the communication in accordance with the respective characteristics associated with each operational constraint in response to determining that the maximum transaction amount for placing the telephone call is less than the minimum transaction amount for accepting the telephone call; and
transmit the communication along the call route without modification.

19. The system of claim 12, wherein an operational constraint of the one or more operational constraints defines a maximum transaction amount for placing the telephone call, and wherein an operational parameter of the one or more operational parameters of the telecommunications service provider defines a minimum transaction amount for accepting the telephone call, wherein the one or more processors is further configured to:
transmit the modified communication along the call route in response to determining that the maximum transaction amount for placing the telephone call is greater than or equal to the minimum transaction amount for accepting the telephone call.

20. A non-transitory computer-readable medium comprising program code that is executable by a processor associated with a telecommunications service provider that causes the processor to:
receive a communication associated with a caller requesting to make a telephone call to a recipient, wherein the communication includes a JavaScript Object Notation (JSON) web token having a payload, wherein one or more operational constraints associated with the telephone call are encoded into the payload prior to receiving the communication;
extract the one or more operational constraints from the payload of the JSON web token, wherein each operational constraint of the one or more operational constraints comprises respective characteristics for transmitting the telephone call;
evaluate each operational constraint of the one or more operational constraints against one or more stored operational parameters of the telecommunications service provider;
modify the communication based the evaluation of each operational constraint and in accordance with the respective characteristics associated with the operational constraint to thereby produce a modified communication; and
transmit the modified communication along a call route.
